(19) United States
(12) Patent Application Publication
(10) Pub. No.: US 2007/0263824 A1
(43) Pub. Date: Nov. 15, 2007

(54) Network resource optimization in a video conference

(75) Inventors: Manjunath S. Bangalore, San Jose, CA (US); Shantanu Sarkar, San Jose, CA (US); Sravan Vadlakonda, Sunnyvale, CA (US); Aseem Asthana, San Jose, CA (US); Randall B. Baird, Austin, TX (US); Luke K. Surazski, San Jose, CA (US); Pascal Huart, Cagnes sur Mer (FR); Sairam Yadlapati, San Jose, CA (US); Prasad Miriyala, Union City, CA (US)

Correspondence Address: THE LAW OFFICES OF BRADLEY J. BEREZNAK, 800 WEST EL CAMINO REAL, SUITE 180, MOUNTAIN VIEW, CA, 94040, US

(73) Assignee: Cisco Technology, Inc., San Jose, CA (US)

(21) Appl. No.: 11/406,112

(22) Filed: Apr. 18, 2006

(51) Int. Cl. H04M 3/42

(52) U.S. Cl. 379/202.01

(57) ABSTRACT

A conferencing system includes a mixer operable to process audio and video packets received from a plurality of endpoint devices, and to transmit a processed audio/video stream back to the endpoint devices. A server connects with the mixer and the endpoint devices. The server is operable to send a first transmission to a first endpoint device that causes the first endpoint device to stop transmitting video packets to the mixer. The server is further operable to send a second transmission to a second endpoint device that causes the second endpoint to start transmitting video packets to the mixer. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims. 37 CFR 1.72(b).

### FIELD OF THE INVENTION

The present invention relates generally to the fields of data networks and communication systems; more specifically, to systems and methods for performing video conferencing over a communications network.

### BACKGROUND OF THE INVENTION

Conferencing systems and methods, in which participants communicate in a conference session or meeting over existing voice and data networks, have been in existence for some time. Examples of conference calling systems include U.S. Pat. No. 6,865,540, which teaches a method and apparatus for providing group calls via the Internet; U.S. Pat. No. 6,876,734, which teaches an Internet-enabled conferencing system accommodating public switched telephone network (PSTN) and Internet Protocol (IP) traffic; U.S. Pat. No. 6,931,001, which discloses a system for interconnecting packet-switched and circuit-switched voice communications; and U.S. Pat. No. 6,671,262, which teaches a system with conference servers for combining IP packet streams in a conference call into combined packet streams, such that the combined IP packet stream utilizes no more bandwidth than each of the original packet streams. A voice conferencing system that uses a packet based conference bridge that receives speech indication signals from individual terminals and then uses those signals to select talkers within the conference is disclosed in U.S. Pat. No. 6,956,828.

In any conferencing system, the usage of network resources is a function of the number of participants. Especially in the case of a video conference, the audio and video media streams normally consume an enormous amount of network bandwidth, and the sheer amount of data involved can easily overwhelm the data processing capacity of the conferencing system. For the same reasons, video conferencing also presents problems with respect to scalability of the conferencing/network infrastructure.

Various proposals have been made to optimize bandwidth usage and data management in an audio/video conferencing environment. For example, U.S. Pat. No. 6,989,856 teaches a distributed video conferencing system in which all video streams, except for the video stream associated with the active speaker, are suppressed at one or more of the media switches that provide an interface from the edge of the network to the core of the network. Although this approach alleviates some of the processing overhead in the core network, the task of handling the large amount of data associated with the video streams arriving from the various end users/end points (EPs) falls to the media switches in the edge network, i.e., between the end user and the media switch. In other words, it is still necessary for the media switches, which are part of the infrastructure, to process the incoming video streams. Additionally, bandwidth consumption remains a problem because the unwanted video streams from end users who are not active speakers are still transmitted over the network before suppression occurs at the media switches. The bandwidth problem is especially acute in wireless networks, where bandwidth between the end user and the media switch is at a premium.

In another approach, U.S. Pat. No. 6,332,153 teaches relaying active speaker information to the EPs so that all of the EPs except for the one designated as the active speaker can suppress their audio streams. That is, audio suppression occurs at the end point source. A major drawback of this approach is that it requires a change in the end point devices in order to process messages/events carrying active speaker information. Moreover, the approach described in the above patent is primarily aimed at suppression of audio packets. A similar approach can be found in commercially-available conferencing software products (see e.g., http://www.arelcom.com/bandwidth.html) which attempt to minimize audio data packet transmission during periods of end user silence.

Thus, what is needed therefore is a mechanism that overcomes the drawbacks of the prior art and optimizes the consumption of network bandwidth and conference bridge resources in a video conferencing system.

By way of further background, U.S. Pat. No. 5,963,217 teaches a network conferencing system that encodes media using text in order to conserve network bandwidth. This text is subsequently translated to speech and video at the endpoint using an appropriate mapping function. Additionally, U.S. Pat. No. 6,925,068 teaches a method for bandwidth savings based on allocation of channels in a wireless physical media environment.

### BRIEF DESCRIPTION OF THE DRAWINGS

The present invention will be understood more fully from the detailed description that follows and from the accompanying drawings, which however, should not be taken to limit the invention to the specific embodiments shown, but are for explanation and understanding only.

FIG. 1 is a conceptual diagram of a conferencing system in accordance with one embodiment of the present invention.

FIG. 2 illustrates an exemplary audio/video conference according to one embodiment of the present invention.

FIG. 3 is a flowchart diagram that illustrates a method of operation according to one embodiment of the present invention.

FIG. 4 is a flowchart diagram that illustrates a method of operation according to another embodiment of the present invention.

FIG. 5 illustrates a graphical user interface utilized in conjunction with a specific embodiment of the present invention.

### DETAILED DESCRIPTION

A mechanism to optimize the consumption of network bandwidth and conference bridge resources by ensuring that only those video endpoints that are actively contributing to the conference session at any given instant transmit the video stream to the conference bridge is described. In the following description specific details are set forth, such as device types, system configurations, protocols, applications, methods, etc., in order to provide a thorough understanding of the present invention. However, persons having ordinary skill in the relevant arts will appreciate that these specific details may not be needed to practice the present invention.

According to one embodiment of the present invention, a mechanism is provided for optimizing the usage of network bandwidth and conference bridge resources by facilitating as bidirectional only those media flows that are active in a given instant in time. The media streams of inactive participants to a conference session are set to receive only (i.e., unidirectional), with the streams ordinarily sent from the video endpoints being suppressed or switched off using standards-based signaling mechanisms and/or media negotiation primitives. Because the activity of the conference participants typically changes throughout the session, the media channel characteristics of the participants are dynamically renegotiated based on various triggering conditions. As a result, network bandwidth consumption is drastically reduced to only a handful of active participants, thereby significantly increasing the network throughput. Additionally, the mechanism of the present invention facilitates an increase in utilization of conference resources by eliminating the redundant processing of the inactive media streams originating from each of the remaining endpoints.

In the context of the present application, active participants or endpoints are defined as those that are in one of the following categories. First, an endpoint that is currently, actively speaking in a conference session. Alternatively, this may be an endpoint that has most recently spoken in the conference session, e.g., the last speaker. The conference bridge may obtain this information periodically based on standard algorithms for determining the loudest speaker or event. Secondly, an active endpoint may be defined as an endpoint that contributes continuously to a video composition. Another category of active endpoint is one that has been locked onto by one or more users as a fixed transmission source. Basically, any endpoint whose audio and/or video stream has an interested receiver is defined as an active endpoint.

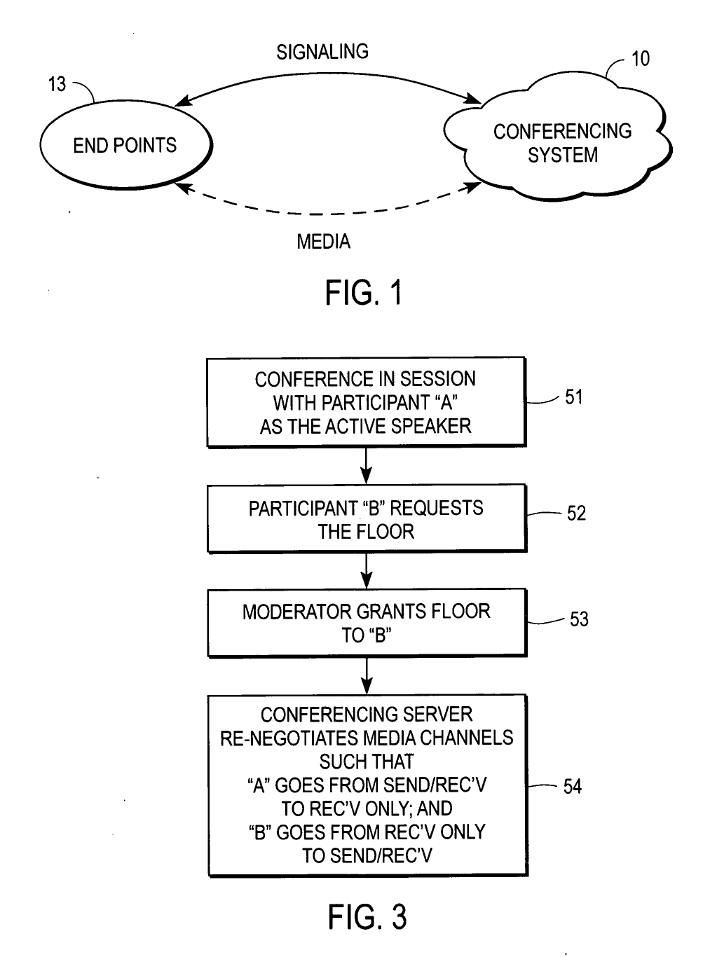

FIG. 1 is a high-level diagram showing a conferencing system 10 and a set of endpoints 13 that avail themselves of the features of the conferencing system in accordance with one embodiment of the present invention. There are two basic paths between conferencing system 10 and endpoints 13: a signaling path and a media path. The media path for the conference participants may include audio/video transmissions, e.g., Real-Time Transport Protocol (RTP) packets sent across a variety of different networks (e.g., Internet, intranet, PSTN, etc.), protocols (e.g., IP, Asynchronous Transfer Mode (ATM), Point-to-Point Protocol (PPP)), with connections that span across multiple services, systems, and devices (e.g., private branch exchange (PBX) systems, VoIP gateways, etc.). In a specific embodiment, the present invention may be implemented in commercially-available IP communication system products such as Cisco's MeetingPlace™ conferencing application allow users to schedule meeting conferences in advance or, alternatively, to set up conferences immediately by dialing out to participant parties. Cisco MeetingPlace™ is typically deployed on a corporate network behind the firewall, and facilitates scheduling of business conferences from a touch-tone or voice over IP (VoIP) telephone, or a computer, using various software clients, such as Microsoft® Outlook, or a web browser. Alternative embodiments of the present invention may be implemented in software or hardware (firmware) installed in an IP communication systems, PBX, telephony, telephone, and other telecommunications systems. Similarly, the signaling path may be across any network resources that may be utilized for transmission of commands, messages, and signals for establishing, moderating, managing and controlling the conference session.

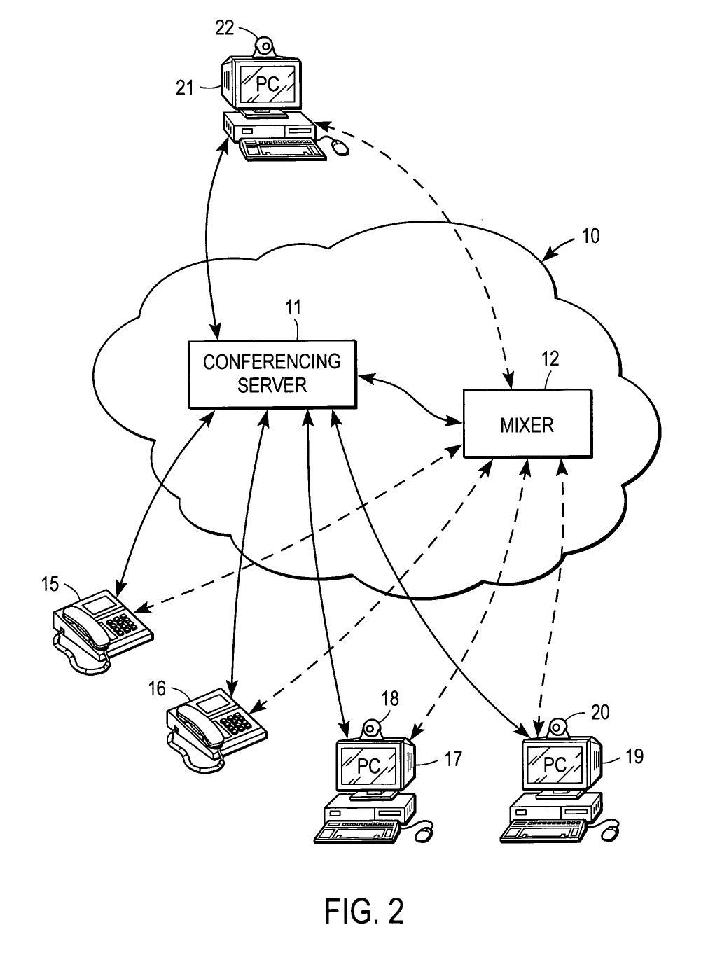

FIG. 2 is a diagram that illustrates an exemplary conference session in accordance with one embodiment of the present invention. Endpoint devices are shown including VoIP phones 15 & 16 and personal computers (PC) 17, 19 and 21. Each of the PCs is configured with an associated video camera; that is, PC 17 has an associated video camera 18, PC 19 has an associated video camera 20, and PC 21 has an associated video camera 22 mounted thereon. In general, an endpoint represents an end user, client, or person who wishes to initiate or participate in an audio/video conference session and via conferencing system 10. Other endpoint devices not specifically shown in FIG. 2 that may be used to initiate or participate in a conference session include a personal digital assistant (PDA), a laptop or notebook computer, a non-IP telephone device, a video appliance, a streaming client, a television device, or any other device, component, element, or object capable of initiating or participating in voice, video, or data exchanges with conferencing system 10.

As can be seen, each of the endpoints shown in FIG. 2 has a separate signaling path connection (shown by the solid line) with a conferencing server of 11, and a media path (shown by the dashed line) connection with a media mixer 12. Media mixer 12 comprises a digital signal processor (DSP) or firmware/software-based system that mixes and/or switches audio/video signals received at its input ports under the control of conferencing server 11. The actual media paths shown in FIG. 2 are established by conferencing server 11. In other words, conferencing server 11 handles all of the control plane functions of the conference session, and is responsible for engaging the necessary media components/resources of media system 12 to satisfy the media requirements of all of endpoints (i.e., endpoints 15, 16, 17, 19, and 21) for a particular conference session. In operation, each of the endpoint devices shown in FIG. 2 may join an audio/video conference session by calling into a conferencing application running on conferencing server 11.

Practitioners in the arts will understand that there exist multiple alternative ways of aggregating/disaggregating the conferencing and mixing resources within the conferencing system “cloud” 10. In other words, the details of conferencing system 10 can vary greatly depending upon application, available resources, network usage, and other particular configuration considerations. For example, the various embodiments described herein are equally applicable to stand-alone, centralized multipoint control units (MCUs) as well as to distributed video conferencing architectures.

In accordance with one embodiment, a conference moderator acts as a trigger to cause the conference bridge to dynamically re-negotiate the media channel directionality of various endpoint devices during a conference session. This moderator function may be facilitated through the use of a graphical user interface (GUI) or a telephony user interface (TUI) running on the moderator's endpoint device. The basic idea is that the conference moderator grants floor control to a conference participant who has requested access to the floor or who has otherwise been waiting in a floor request queue. When a participant receives the floor from the moderator, the conferencing server automatically renegotiates that participant's media channel characteristics, changing the media channel characteristics of that endpoint from receiver-only to send & receive, i.e., from unidirectional to bidirectional transmission. In other words, the media characteristics of the endpoint device are attached to the floor control grant such that only the active speaker endpoint sends video packets to the media mixer—all the remaining endpoints have their video streams turned off or suppressed.

FIG. 3 is a flowchart diagram that illustrates a method of operation according to the above-described embodiment of the present invention. The process starts (block 51) with a participant “A” having active speaker status (floor control) in the conference session. At this point, participant (endpoint) “A” is the only endpoint sending both audio and video RTP packets to the mixer. That is, all of the other endpoints are in a unidirectional (receive-only) mode in which video streaming from the endpoint device is turned off or suppressed. Note, however, that even though video output is suppressed at the endpoint device, in certain embodiments, audio streaming may continue to be enabled. In other words, even though a participant is not the active speaker for purposes of a video streaming, the other endpoints may continue to send audio streams to the media mixer for mixing and subsequent output to the conference participants.

The next event in the method of FIG. 3 occurs when a participant “B” requests control of the floor (block 52). The moderator may be alerted to this request in a variety of different ways, for example, via a visual indicator on a graphical user interface. Regardless of how the conference moderator becomes aware of the participant's request for floor control access, when the moderator acts upon this request and grants floor control to participant “B” (block 53), the following occurs. The moderator console (e.g., GUI) sends a message to the conference server, causing the server to implement the signaling required to take the endpoint device of participant “B” from a receive-only to a send & receive mode of operation. At the same time, the media channel of participant (endpoint) “A” is re-negotiated from send & receive to receive-only (block 54).

Practitioners in the art will appreciate that the method described above may be completely automated by the conferencing system in accordance with a floor control algorithm or floor control access system. In other words, it is not necessary that a conference moderator act to grant individual floor control access to participants on a continual basis.

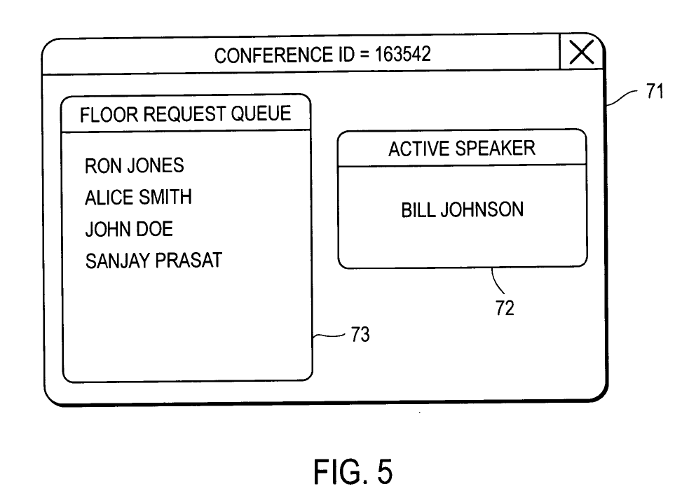

By way of further example, FIG. 5 illustrates a graphical user interface (GUI) 71 associated with an application running on a PC of a conference moderator according to a specific implementation. GUI 71 includes respective floor request queue and active speaker fields 73 and 72, respectively. Floor request queue 73 is shown populated with the names of four participants (i.e., Ron Jones, Alice Smith, John Doe, and Sanjay Prasat) who have clicked a button on their endpoint devices to request floor control grant, i.e., active speaker, status. The one participant (Bill Johnson) shown in the active speaker field 72 represents the only endpoint that has a bidirectional media channel, meaning that the endpoint of the active speaker is both sending/receiving video packets to/from the media mixer. In one possible implementation of GUI 71, the conference moderator may click on a name in floor request queue 73 to make that person the new active speaker, thereby moving the current active speaker out of a field 72.

In accordance with another embodiment of the present invention, the conference server, upon detecting an active participant in the conference session, signals all non-active endpoints to suppress their video transmission towards the conference bridge (mixer) by setting the media direction parameter of those endpoints to receive-only. The mixer basically detects the one or more loudest speakers in the conference session and designates them the active speaker(s). The conferencing server then signals the non-active endpoints to suppress the video streaming output from the other endpoints to the mixer or conference bridge. As the active speaker status dynamically changes during a conference session, media channel characteristics of the various endpoints are appropriately renegotiated.

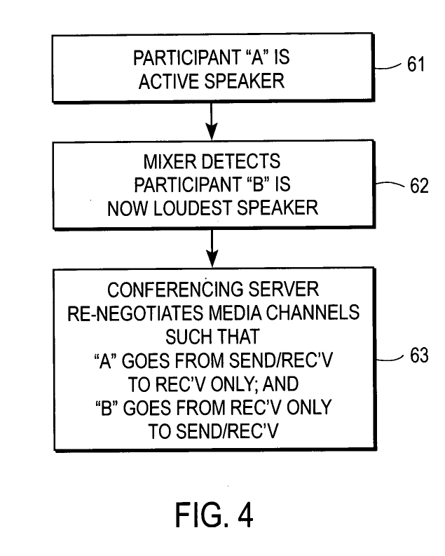

FIG. 4 is a flowchart diagram of a method of operation according to the above-described embodiment of the present invention. The process begins at block 61, where a participant “A” is the active speaker (e.g., based on a detection algorithm that determines participant “A” is currently speaking the loudest). By virtue of its active speaker status, the endpoint associated with participant “A” is enabled by the conference server to send and receive video packets to the conference bridge. All other endpoints have been instructed, via signaling, to suppress video output. At block 62, the media mixer detects that participant “B” is now the loudest speaker in the conference. As a result, the server renegotiates the video media channels for both “A” and “B” such that participant “A” goes from a bidirectional to a unidirectional video channel, while participant “B” goes from unidirectional to a bidirectional video channel (block 63). (Audio channels remain bidirectional at all times.)

Note that in this embodiment the audio streams from each of the endpoints to the mixer are bidirectional, but the video streams are selectively controlled via signaling of the conferencing server such that each endpoint operates in either a receive-only or a send/receive video streaming directional mode. Practitioners in air will appreciate that the change in video transmission directional mode (e.g., unidirectional or bidirectional) for the involved participants may take place in accordance with a variety of different protocols and different signaling mechanisms. This may simply involve the conference server sending a request message to the endpoint device to stop sending Real-Time Transport Protocol (RTP) packets. For instance, in a Session Initiation Protocol (SIP) environment, a reINVITE or UPDATE message may be sent to an endpoint device to suppress and re-enable video transmission. In SIP, a method for suppression and enablement of a video stream may include a MIME-encoded body part containing Session Description Protocol (SDP). The SDP, in turn, contains information about each media stream. One item of the media stream description concerns the directionality of the media. Therefore, by changing a video media stream description marked as “send/recv” to one marked as “send-only” or “recv-only”, either the server or the endpoint can convert a bidirectional video stream to a unidirectional one. Similar, by changing the video media stream description back to “recv-only”, bidirectional flow of video can be restored.

In yet another embodiment of the present invention, each endpoint device includes a voice activity detection (VAD) enabled device or module that can distinguish between silence, breathing, wind, noise, etc., and ordinary speech. In operation, the VAD device triggers video transmission to the mixer only when it detects someone talking. Basically, when speech or voice activity is detected, the endpoint, rather than the conference system, quickly negotiates (with the conferencing server) a change in the media channel characteristics from a receiver-only video transmission mode to a send/receive video transmission mode. In all other cases (e.g., silence, breathing, wind, noise, etc.) video streaming to the mixer is suppressed or turned off.

In a slight variation of the above embodiment, instead of immediately changing to a bidirectional video transmission mode upon detection of voice activity, the endpoint may first use existing floor control mechanisms and algorithms to request control of the floor from the conference moderator or conferencing server. Only after the endpoint has been granted control of the floor would the conferencing server renegotiate the media channel characteristics of the endpoint to allow the endpoint to begin sending video packets to the mixer.

In still another embodiment of the present invention, an in-band signaling mechanism, such as Named Signaling Event (NSE), may be utilized to indicate to the endpoint device to switch off video transmission when there is no audio being received at the mixer from the endpoint device. This approach is similar to the previously described embodiments in that the conferencing bridge indicates to the an endpoint device that it should stop/start video transmission, but in this case the payload (RTP) itself is utilized as the command transmission medium instead of signaling, making this embodiment protocol-independent and codec-independent.

In yet another embodiment of the present invention, a video encoding scheme may be enhanced to signal to the endpoint device whether it should transmit or not, in a manner similar to “freeze picture” control command in H.26x Video codecs. This may be accomplished in a H.323 network using H.245 media control primitives. (H.245 is a control signaling protocol in the H.323 multimedia communication architecture, and is used for of the exchange of end-to-end H.245 messages between communicating H.323 endpoints/terminals.) A video stream in a given direction can be terminated by sending a Close Logical Channel (CLC) command, which has the effect of closing the communication channel between two endpoints. Similarly, the communication channel can be reopened for transport of audiovisual and data information by sending an Open Logical Channel (OLC) command.

In another embodiment, the H.245 FlowControl command with a bit rate of zero can be used to leave the video channel established but unable to transmit any data. When video is again required of the channel, a second FlowControl command with the original video bit rate can be sent, allowing video to flow once again.

It should be understood that elements of the present invention may also be provided as a computer program product which may include a machine-readable medium having stored thereon instructions which may be used to program a computer (e.g., a processor or other electronic device) to perform a sequence of operations. Alternatively, the operations may be performed by a combination of hardware and software. The machine-readable medium may include, but is not limited to, floppy diskettes, optical disks, CD-ROMs, and magneto-optical disks, ROMs, RAMs, EPROMs, EEPROMs, magnet or optical cards, propagation media or other type of media/machine-readable medium suitable for storing electronic instructions. For example, elements of the present invention may be downloaded as a computer program product, wherein the program may be transferred from a remote computer or telephonic device to a requesting process by way of data signals embodied in a carrier wave or other propagation medium via a communication link (e.g., a modem or network connection).

Additionally, although the present invention has been described in conjunction with specific embodiments, numerous modifications and alterations are well within the scope of the present invention. Accordingly, the specification and drawings are to be regarded in an illustrative rather than a restrictive sense.

We claim:

1. A conferencing system comprising:
a mixer operable to process audio and video packets received from a plurality of endpoint devices, and to transmit a processed audio/video stream back to the endpoint devices; and
a server for connection with the mixer and the endpoint devices, the server being operable to send a first transmission to a first endpoint device that causes the first endpoint device to stop transmitting video packets to the mixer, and to send a second transmission to a second endpoint device that causes the second endpoint to start transmitting video packets to the mixer.

2. The conferencing system of claim 1 wherein the first and second transmission occur responsive to a triggering event.

3. The conferencing system of claim 1 wherein the triggering event comprises detection, by the server, of voice activity in the media stream.

4. The conferencing system of claim 1 wherein the triggering event comprises the second endpoint obtaining a grant of the floor of a conference session.

5. The conferencing system of claim 1 wherein the triggering event comprises an input command of a conference moderator user interface.

6. The conferencing system of claim 1 wherein the first and second transmissions comprise Session Initiation Protocol (SIP) transactions.

7. The conferencing system of claim 1 wherein the first and second transmissions comprise H.245 FlowControl messages.

8. A computer for connecting with a conferencing server to control media presentation of a conference session, comprising:
a display;
a program that runs on the computer to produce a graphical user interface on the display, the graphical user interface providing a conference moderator using the computer with a list of conference participants and the ability to designate one of the conference participants as an active speaker in the conference session, the graphical user interface generating output signals in response to a conference participant being designated as the active speaker; and
an external interface for transmitting the output signals to the conferencing server, the output signals causing the conferencing server to renegotiate the media channel characteristics of an endpoint device associated with the conference participant such that the endpoint device starts sending video packets when the conference participant is designated as the active speaker, with all endpoint devices of other conference participants suppressing video transmission.

9. A conferencing system comprising:
a mixer operable to process audio and video packets received from a plurality of endpoint devices, and to transmit a processed audio/video stream back to the endpoint devices; and
means for enabling video transmission from a first endpoint device along a first media channel to the mixer, and for disabling video transmission from a second endpoint device along a second media channel in response to a triggering condition.

10. The conferencing system of claim 9 wherein the means comprises a server that operates to dynamically renegotiate characteristics of the first and second media channels using a signaling mechanisms and/or media negotiation primitives responsive to the triggering condition.

11. The conferencing system of claim 9 wherein the triggering condition comprises a voice activity detection signal sent from the first endpoint to the server.

12. The conferencing system of claim 9 wherein the triggering condition comprises the first endpoint obtaining floor control of a conference session.

13. The conferencing system of claim 9 wherein the triggering condition comprises an input command of a conference moderator user interface.

14. The conferencing system of claim 9 wherein the means is further for enabling video transmission from only the first endpoint device in response to a triggering condition.

15. A processor-implemented method for managing a conference session comprising:
detecting a first participant as a loudest speaker out of a group of participants to a conference session;
enabling video transmission from a first endpoint device associated with the first participant over a first media channel to a conferencing bridge;
suppressing video transmission from each endpoint device associated with a remainder of the group of participants;
automatically detecting a second participant from the group of participants as a new loudest speaker;
suppressing video transmission from the first endpoint device; and
enabling video transmission from a second endpoint device associated with the second participant over a second media channel to the conferencing bridge.

16. The processor-implemented method of claim 15 wherein the step of suppressing video transmission from the first endpoint device comprises renegotiating the first media channel to transition from a bidirectional to a unidirectional channel.

17. The processor-implemented method of claim 15 wherein the step of enabling video transmission from the second endpoint device comprises renegotiating the second media channel to transition from a unidirectional to a bidirectional channel.

18. The processor-implemented method of claim 15 wherein the step of enabling video transmission from the second endpoint device comprises sending a signal from a conference server to the second endpoint device.

19. A processor-implemented method for managing a conference session comprising:
mixing audio streams received from first, second and third endpoint devices, and a video stream received from the first endpoint device;
transmitting a mixed audio/video output stream back to the first, second and third endpoint devices;
automatically sending a first transmission to the first endpoint device and a second transmission to the second endpoint device in response to a triggering condition, the first transmission causing the first endpoint device to suppress the video stream, and the second transmission causing the second endpoint to start streaming video packets over a media channel.

20. The processor-implemented method of claim 19 wherein the triggering condition comprises the second endpoint obtaining floor control of the conference session.

21. The processor-implemented method of claim 19 wherein the triggering condition comprises a voice activity detection signal sent from the second endpoint to a conference server.

22. The processor-implemented method of claim 19 wherein the triggering condition comprises an input command of a conference moderator user interface.
